(19) United States
(12) Patent Application Publication
(10) Pub. No.: US 2024/0116213 A1
(43) Pub. Date: Apr. 11, 2024

(54) METHOD FOR THE PRODUCTION OF THREE-DIMENSIONAL MOLDED PARTS FROM A FIBER-CONTAINING MATERIAL AND FIBER PROCESSING DEVICE

(71) Applicant: Kiefel GmbH, Freilassing (DE)

(72) Inventor: Matthias Hausmann, Unken (AT)

(21) Appl. No.: 18/481,391

(22) Filed: Oct. 5, 2023

(30) Foreign Application Priority Data
Oct. 7, 2022 (DE) 10 2022 125 886.6

(51) Int. Cl. B27N 5/02; B27N 1/00

(52) U.S. Cl. CPC B27N 5/02; B27N 1/00

(57) ABSTRACT

A method for producing three-dimensional molded parts from a fiber-containing material and a fiber processing device are described. In this case, a provision of separated fibers, an arrangement of the separated fibers to form at least one preform, wherein the at least one preform substantially corresponds to the shape of a molded part to be produced, and a pressing of the at least one preform to form a three-dimensional molded part take place. The fiber processing device at least has a feeding device for providing separated fibers; a premolding device, which has at least one premold for forming preforms from fibers fed separately, which corresponds to the final form of the molded part to be produced; a transfer device for transferring preforms provided via the at least one premold and made of fiber-containing material; and a molding device for pressing preformed preforms to form finished three-dimensional molded parts.

### PRIORITY CLAIM

The present application claims priority under 35 U.S.C. § 119 to German Patent Application No. DE 10 2022 125 886.6, filed Oct. 7, 2022, the disclosure of which is incorporated by reference herein in its entirety.

### TECHNICAL FIELD

A method for the production of three-dimensional molded parts from a fiber-containing material and a fiber processing device for producing three-dimensional molded parts from a fiber-containing material are described.

### DESCRIPTION OF RELATED ART

Fiber-containing materials are frequently used, for example, to produce packaging for food (e.g., trays, capsules, boxes, etc.) and consumer goods (e.g., electronic devices, etc.) as well as beverage containers. Everyday items, such as disposable cutlery and tableware, are also made from fiber-containing material. Fiber-containing materials contain natural fibers or artificial fibers. Recently, fiber-containing material is increasingly used that has or is made of natural fibers which can be obtained, for example, from renewable raw materials or waste paper.

Fiber-containing materials can be processed in a wet state or a dry state. For example, fibers can be separated and the separated fibers can be joined to form a nonwoven-like layer, wherein the nonwoven-like layer can subsequently be processed further. The water content can here, for example, be in a range of 0 to 60% by weight.

In the case of dry processing, wherein the nonwoven or the separated fibers can be or are only slightly wetted and/or provided with an additive in order, for example, to influence the connection properties of the fibers and/or mechanical and chemical properties of a finished product, reference is generally made to a so-called dry-fiber processing process. In dry processing, the moisture content can, for example, be 0 to 35% by weight.

Additives can also have an effect on color, barrier properties and mechanical properties.

When fibers are processed in a dry state, the fibers are usually provided first, for which purpose the fibers are separated from a fiber-containing material. The separation frequently takes place via mills or other comminution devices, such as hammer mills, etc. In this case, separation takes place in such a way that individual fibers or fiber bundles are produced. Fiber bundles include individual fibers which are connected, wherein such a fiber bundle generally hardly contains more than 3-5 fibers and thus also falls under the term “separated fibers” within the meaning of the technical teaching described herein.

The separated fibers are then generally brought via air as the carrier medium onto a screen belt, wherein, via the screen belt, the fibers are sucked and are arranged in a relatively loose compound on the screen belt to form a nonwoven-like layer. The nonwoven-like layer can also be referred to as a “fluff pulp” layer. Subsequently, the nonwoven-like layer is connected to a support layer (tissue) and/or provided with a coating, e.g., by spraying. Thereafter, the layer passes via a conveying device, such as a transport belt, into a pressing station, wherein the layer is pressed at high pressure and high temperatures in accordance with molding tools to form three-dimensional molded parts. During pressing, the molded parts are simultaneously removed from the layer. Such a method and a plant for carrying out the method are known, for example, from WO 2017/160218 A1.

A disadvantage of the known methods and devices is that a relatively large remainder of fiber-containing material that is not processed remains in a residual layer. Although this residual layer can be returned again and comminuted in a hammer mill, several disadvantages arise in the process. On the one hand, a return must be provided, which enlarges the structure of the plant and expands the method by at least one additional processing.

Finally, it may be necessary to remove a tissue layer from the residual layer before the latter is fed to additional processing, because said tissue layer contains fibers of a different material or cannot be easily comminuted. It may thus be necessary, for example, to purchase a different type of comminution device, which is expensive (purchase, operation) and is more complicated to control. As a result of a coating of the nonwoven-like layer, it may also be necessary to carry out a pretreatment of the residual layer because the coating does not permit separation since substances which must not be present in the material are contained therein and are only provided as an outer or inner layer in molded parts.

Another disadvantage of the known production variants is that three-dimensional molded parts produced in this way are greatly limited in terms of shape. This is because the nonwoven-like material is “deep drawn” (stretched) in the molding tools, as is known in thermoforming of plastics. The advantage of plastics is that they can be deep drawn, wherein the material thickness can be kept relatively constant during the molding process and after production. This also applies to molded parts with relatively large depths (e.g., cups). A nonwoven-like layer, on the other hand, cannot be deformed to such an extent because, otherwise, especially on deep-drawn side regions, major differences in the wall thickness and even damage to the molded parts can occur because the fiber-containing material is not flowable. As a result, only molded parts with low mold depths and simple geometries are produced since molded parts with steep flanks, sharp radii or additional geometric elements, such as ribs within the molded part, cannot be produced or can only be produced with great difficulty, e.g., by complicated premolding, in a dry-fiber molding process (dry-fiber processing method). Moreover, a material addition in a nonwoven-like layer has previously been provided in order to achieve defined wall and material thicknesses during a stretching of the nonwoven-like layer and thus to enable “deep-drawing” after all.

Thus, the dry-fiber processing method is limited to only a small range of molded parts, even though it would be desirable to also apply the method to products that have previously been produced only in a wet process (wet-fiber processing method). However, a wet-fiber processing method has an enormous water consumption and is therefore disadvantageous with regard to the required resources in comparison to a dry-fiber processing method.

### SUMMARY OF DISCLOSED EMBODIMENTS

### Object

The object is therefore to specify a solution for the production of three-dimensional molded parts that eliminates the disadvantages of the prior art, produces substantially no waste during production and is subject to no restrictions whatsoever with regard to the mold depth in the production of three-dimensional molded parts in a dry-fiber processing method.

### Solution

The aforementioned object is achieved by a method for the production of three-dimensional molded parts from a fiber-containing material, at least having the following steps:
providing separated fibers,
arranging the separated fibers to form at least one preform, wherein the at least one preform substantially corresponds to the shape of a molded part to be produced, and
pressing the at least one preform to form a three-dimensional molded part.

The method is characterized in that the separated fibers are arranged to form a preform which substantially corresponds to the final form and shape of the three-dimensional molded part to be produced, so that on the one hand the form is already predetermined and no further stretching thus occurs, which allows the production of complex molded parts with large mold depths, and, moreover, no waste accumulates during production. Since no stretching occurs, a material addition can also be dispensed with, which simplifies production since thinner preforms can already be produced and the pressing of thinner preforms can be carried out more quickly and more simply.

The formation of the preform “substantially of the shape of a molded part to be produced” means that a surface, e.g., inner or outer surface, generally has the final form and shape of the three-dimensional molded part to be produced. The respectively other surface opposite to the three-dimensional preform projects beyond the later outer or inner surface, i.e., has a greater wall thickness than the finished molded part because the fibers are loosely arranged on a corresponding premold. Only after the arrangement are the fibers then pressed against one of the surfaces (inner or outer surface) via corresponding molding tools, wherein the wall thickness then decreases and the material or the fibers are compressed.

Advantageously, in the production of three-dimensional molded parts in a dry-fiber processing method, waste thus does not accumulate and complex geometries can be achieved, wherein the processing (pressing, arranging, etc.) is also simplified.

In further embodiments, after arranging the separated fibers to form at least one preform, pre-pressing of the preform can take place, wherein a first compression step is carried out so that the preform is already compressed to a definable extent before the pressing. This achieves that no support layers (e.g., tissue) or other stabilizing measures or means are required, and the preforms can be easily transferred and displaced without being damaged. In the prior art, pre-pressing for pre-compression was not possible due to the subsequent stretching in the molding tool, because the layer would otherwise no longer have been able to be deformed without being damaged. A pre-pressing can take place, for example, in a premold in which the arrangement of the separated fibers to form a preform takes place. In still further embodiments, premolding can take place in a downstream molding tool, e.g., in a molding tool for pressing to form a three-dimensional molded part, wherein the pressing can also take place in a premold in further embodiments. The premolding can take place, for example, with the aid of a stamp or a premold which are designed to be rigid. In further embodiments, premolding can also take place with the aid of a flexible blank-mold body (e.g., made of silicone) and/or by means of inflatable or filled blank-mold bodies.

In further embodiments, the arrangement of the separated fibers and the pressing of the at least one preform can take place continuously and coordinately or discontinuously. For example, preforms can be produced prior to further processing to form three-dimensional molded parts. The preforms thus produced can then be stored, transported and/or further treated for later pressing. For example, preforms can be coated and/or colored. In further embodiments, as many preforms can always be produced as are pressed in a subsequent processing step. For example, such a coordinated production can be carried out in a fiber processing device.

In further embodiments, fibers from a fiber-containing material can be separated for the provision in an upstream step. For this purpose, corresponding separating devices, such as mills, etc., can be used. Moreover, the fibers can be separated, for example, in an upstream processing step, wherein the fibers are either fed directly to the processing, e.g., the arrangement on a premold, or the fibers can be stored, e.g., in storage containers, and fed to a later processing. After the separation, a coating for achieving definable properties and/or for coloring the separated fibers can additionally be carried out.

In further embodiments, the pressing of preforms to form three-dimensional molded parts can take place under the action of heat. This achieves improved compression and connection of the fibers. The pressing advantageously takes place at a temperature in the range of 60° C. to 300° C. In this case, the preforms can furthermore be pressed in a temperature range of 100° C. to 250° C.

In further embodiments, the separated fibers of at least one preform can be fed to a premolding device, wherein the separated fibers are distributed uniformly onto the surface of the preform and the preform substantially corresponds to the final form of the molded part to be produced, as a result of which a preform is formed. The surface of the premold forms the contact surface for the fibers, which later form the inner or outer side of the three-dimensional molded part. The fibers are applied to the surface in a relatively loose composite so that, analogously to the formation of a nonwoven-like layer, as in the prior art, a correspondingly three-dimensional nonwoven-like layer forms on the surface of the premold, wherein the preform formed thereby then has substantially the form and shape of the three-dimensional molded part to be produced.

In further embodiments, after the premolding, the at least one preform can be transferred to a molding device and the at least one preform can be pressed in the molding device to form a three-dimensional molded part. As a result of the pressing, the fibers of the preform are connected to one another and the preform is compressed to form the finished three-dimensional molded part. The pressure which is applied to press the preforms to form three-dimensional molded parts can be at least 1 MPa. In particular, pressing can be carried out in a range of 4-80 MPa. An optionally provided pre-pressing can take place, for example, in a range of 0.1 MPa to 3 MPa, preferably in a range of 0.1 MPa to 0.6 MPa.

In the aforementioned pressure and/or temperature ranges, a particularly good connection of the fibers with regard to their mechanical properties and characteristic values is achieved. The reason for this is the resulting aggregation of the fibers with one another (“fibril aggregation”).

In further embodiments, separated fibers can be blown into or onto the surface of the premold and/or sucked over the surface of the premold. For this purpose, a gas or gas mixture (e.g., air) can be used as a carrier medium which provides a transport of the separated fibers onto the surface of the premold. Sucking the fibers can achieve that the fibers collect on the surface of the premold. A homogeneous layer thickness can be achieved, for example, in that the suction effect is lower in the regions of the surface that are already occupied by multiple fibers.

In further embodiments, the production of preforms from separated fibers in a premold and the pressing of preforms to form three-dimensional molded parts can take place discontinuously.

The aforementioned object is also achieved by a fiber processing device for producing three-dimensional molded parts from a fiber-containing material, at least having a feeding device for providing separated fibers; a premolding device which has at least one premold for forming preforms from fibers fed separately, which corresponds to the final form of the molded part to be produced; a transfer device for transferring preforms provided via the at least one premold and made of fiber-containing material; and a molding device for pressing preformed preforms to form finished three-dimensional molded parts.

The fiber processing device enables the production of three-dimensional molded parts which can have any mold depth at a constant wall thickness, wherein no waste is produced. Advantageously, the separated fibers are introduced directly into a premold which corresponds to the final form of the three-dimensional molded part. In this way, any mold depths can be achieved without the molded part having different wall thicknesses, etc. This also achieves an improvement in comparison to dry-fiber production methods known from the prior art, in which only a small mold depth is achieved. Since a certain “deep drawing” or stretching always occurs in the prior art, differences in wall thickness thus also always result at least partially. This is excluded by the fiber processing device specified herein, since only pressing of preforms, but not stretching, occurs in the molding device of the fiber processing device because the three-dimensional shape is already produced in advance during the production of the starting material for the pressing and “deep drawing” is no longer necessary.

Overall, molded parts with thinner walls can thus also be produced because a deformation-related addition, as required in the prior art, is no longer necessary. This additionally reduces the material consumption.

Furthermore, the molding process in the molding device is simplified because only pressing of preforms occurs therein. For this purpose, the molding device has at least one molding tool which can, for example, have a positive and a negative mold half. A deformation (stretching) of molded parts does not have to be taken into account in the molding device because the preforms already have the final form so that, for example, the closing speed of a molding device can be increased, which overall reduces the cycle time for producing at least one three-dimensional molded part. Furthermore, the molded parts can be of thin-walled design because no deformation-related addition is required so that the time required for pressing due to the thinner wall thickness is also lower than in the prior art. The cycle time for the production of at least one molded part can thus be further reduced.

Furthermore, for the fiber processing device, auxiliary elements for forming molded parts can be dispensed with. No pre-stretching stamps or the like are thus required. Moreover, no cover layers, etc., which support the nonwoven-like material during deformation in the prior art, are required.

Finally, more complex geometries, which could not be produced with the previously known means due to the above-described limitations, can thus also be produced in three-dimensional molded parts.

The feeding device serves to provide separated fibers and can be designed accordingly. The feeding device can, for example, feed the fibers to the premolding device via a carrier medium. The at least one preform of the premolding device is designed such that a preform, which substantially has the shape of the three-dimensional molded part to be finally produced, can be produced via the premold. In this case, the preforms produced in this way are substantially equivalent to a nonwoven-like layer (fluff pulp layer) from the prior art, with the difference that the preforms are not applied to a carrier in a flat design but are attached to or on a premold which corresponds to the final geometry and form of the three-dimensional molded part to be produced. The preforms provided via the at least one premold are received by the transfer device and transferred to the molding device. The molding device has, for example, two tool halves which, in the closed state of the molding device, form a cavity in which preforms are pressed. The transfer device can, for example, have a form that is adapted to the preform and is placed onto a preform for receiving the same and sucks the preform in order to then transfer it to the molding device or the corresponding molding tool. In further embodiments, the form of the transfer device can easily press the preform against the preform before the suction, so that pre-pressing takes place, which serves to solidify the preform and to stabilize the structure thereof.

In further embodiments, the at least one preform can have a surface which has openings at least partially. The partially provided openings on the surface can serve to support the deposition of fibers on the surface. A partial arrangement of openings allows, for example, sucking of fibers to be controlled, so that, for example, regions are more covered with fibers than other regions. For example, bottom or edge regions of a molded part can be deliberately formed to be thicker than side walls, for example.

In particular, in further embodiments, the feeding of the fibers can be selected such that a homogeneous covering is achieved. For this purpose, feed channels and openings as well as guide means for feeding the fibers, which enable and/or support homogeneous covering, can be provided accordingly. Uniform feeding can be achieved, for example, by a corresponding number of feed openings or feed cross-sections. Furthermore, feed openings can have a defined orientation with respect to the surface of the preform so that the fibers always impinge on the surface at a definable angle, for example, wherein the quantity of fed fibers can substantially be kept the same over the entire surface via a corresponding number and form of feed openings.

In further embodiments, the size of the openings can be different. As a result, the quantity of fibers in the region of the openings can likewise be different. In particular, it is possible with the above designs of the openings to achieve a homogeneous distribution of the fibers on the surface of a premold, wherein, for example, the openings are designed and arranged in accordance with the feeding direction of the fibers and the speed thereof.

In further embodiments, the surface can have a mesh-like or screen-like structure. Mesh-like or screen-like structures enable flat homogeneous sucking of fibers so that a uniform covering of the surface of a preform can be achieved in order to obtain a preform with a constant wall thickness. In particular, materials with mesh-like or screen-like structures can be produced easily in different molds. With such structures, it is also possible to provide openings on all surface regions of a preform with complex geometries and to thus achieve sucking of fibers. Preforms with mesh-like or screen-like structures can be produced, for example, from a wire mesh or a plastic mesh or a plastic screen. Preforms with such structures can, for example, also be easily produced by means of 3D printing and can represent complex geometries. In addition, preforms produced by means of 3D printing have the advantage that the openings are not compressed or stretched, as can occur, for example, when reshaping flat materials with a mesh-like or screen-like structure.

In further embodiments, fibers separated via the openings in the surface of the at least one premold can be sucked via a suction device. The fibers are sucked by the suction device via corresponding channels, which are provided in the premold and lead to the openings, and then accumulate on the surface of the at least one premold. In alternative embodiments, the premold can also be hollow, wherein a connection to a suction device is provided so that sucking of fibers on the entire surface of the premold takes place via the cavity in the premold. In further embodiments, the surfaces of a premold can have differently formed regions with different openings and/or channels so that the sucking of fibers on the regions is of different strength, for example in order to achieve different layer thicknesses of fibers in preforms, which then lead to regions of different thicknesses in the finished molded parts.

In further embodiments, the feeding device can have a fan via which separated fibers can be introduced into the at least one premold. The fan can support the introduction of fibers in addition or as an alternative to sucking via a suction device. For this purpose, it is possible to provide further means which provide a defined deflection and/or beam direction of the fed carrier medium (e.g., air) with the entrained fibers in order to achieve a corresponding distribution of the fibers on the surface of a premold. Such means can, for example, have guide flaps, wings or controllable deflection elements.

In further embodiments, the feeding device can have at least one feed duct which opens into the at least one premold. Via the feed duct, the separated fibers can be introduced directly into the at least one premold, for example with the aid of a carrier medium. The feed duct can be designed such that directed feeding of the fibers is achieved. The design of the feed duct can thus be decisive for the direction and quantity of the fed fibers. For this purpose, the cross-sectional area and/or the cross-sectional form of the feed duct over the length thereof can be designed accordingly, wherein the design of the region of the feed duct facing the surface is in particular decisive for the feeding (quantity, direction) of the fibers.

In further embodiments, the feed duct can terminate flush with the surface of the at least one premold. In these embodiments, the feed duct can be designed such that it forms, for example, a distribution cone above or within the premold, wherein the distribution cone spans the surface of the premold or projects into the latter. In these embodiments, the fibers are introduced via, for example, a carrier medium into the region between the surface of the premold and the wall of the feed duct delimiting the distribution cone and can be distributed uniformly there. In further embodiments, the design of this wall achieves that a turbulent flow of fibers prevails in this space, wherein the fibers can additionally be sucked via a corresponding design of the surface. The whirled-about fibers can in this case be distributed substantially uniformly within the space. The fibers located in the region of the surface of the premold are arranged via suction on the surface by the suction effect and remain there. The wall can, for example, have redirection wings and/or deflection wings for swirling and distributing the fibers.

In further embodiments, the fiber processing device can furthermore have a mill for providing separated fibers from a starting material. The mill is understood here to mean any device which is capable of separating and/or comminuting the fibers from a starting material with a relatively solid structure or connection of the fibers.

The fiber processing device can furthermore have a device which carries out pre-pressing of preforms after the arrangement of the fibers on the surface of the premold. Thus, prior to the transfer of the preforms, pre-pressing can also take place, for example by means of a transfer tool, which first presses the preform downward and thereafter sucks the latter, for example, and transfers it to a molding tool for subsequent pressing.

Further features, embodiments and advantages result from the following illustration of exemplary embodiments with reference to the figures.

### BRIEF DESCRIPTION OF THE FIGURES

In the drawings:

FIG. 1 shows a schematic representation of a fiber processing device for producing three-dimensional molded parts from a fiber-containing material.

FIG. 2 shows a schematic representation of a premold of a premolding device of a fiber processing device.

FIG. 3 shows a schematic representation of a surface portion of the surface of a premold with a mesh-like structure.

FIGS. 4-11 show a schematic representation of individual production steps in the production of three-dimensional molded parts from a fiber-containing material.

FIGS. 12, 13 show schematic representations of three-dimensional molded parts.

FIG. 14 shows a method for the production of three-dimensional molded parts from a fiber-containing material.

### DETAILED DESCRIPTION OF EXEMPLARY EMBODIMENTS

Exemplary embodiments of the technical teaching described herein are shown below with reference to the figures. Identical reference signs are used in the figure description for identical components, parts and processes. Components, parts and processes which are not essential to the technical teachings disclosed herein or which are obvious to a person skilled in the art are not explicitly reproduced. Features specified in the singular also comprise the plural unless explicitly stated otherwise. This applies in particular to statements such as “a” or “one.”

The figures show exemplary embodiments of a fiber processing device 100 for producing three-dimensional molded parts 300 from a fiber-containing material, of components of a fiber processing device 100 and of methods for the production of three-dimensional molded parts 300 from a fiber-containing material. The exemplary embodiments shown here do not represent any restriction with regard to further embodiments and modifications of the described embodiments. Thus, alternative embodiments for individual exemplary embodiments can also be provided alternatively or cumulatively in other exemplary embodiments.

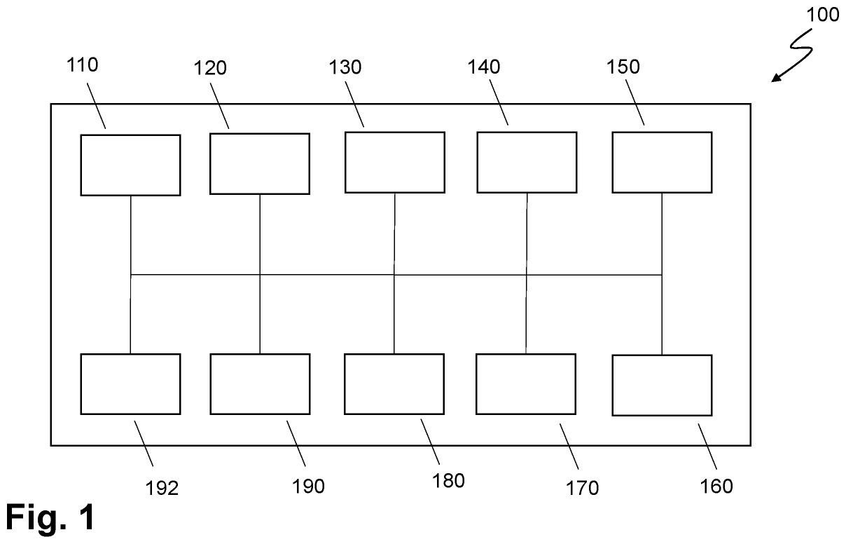

FIG. 1 shows a schematic representation of a fiber processing device 100 for producing three-dimensional molded parts 300 from a fiber-containing material. The fiber-containing material for further processing can be provided as separated fibers 500, for example. In further embodiments, the processing also includes a separation of fibers from a fiber-containing original material. In further embodiments, fiber processing devices 100 can have a separating device, such as a mill 110, for example. Such a separating device is not provided in further embodiments of fiber processing devices 100. In these fiber processing devices 100, already separated fibers 500 are fed.

In addition, fiber processing devices 100 in further embodiments are designed to process preforms 200 which were produced in an upstream processing step in another fiber processing device 100. The preforms 200 can, for example, be stored and subsequently fed to further processing. Likewise, the separation of fibers 500 can take place in an upstream processing step and the fibers 500 can be stored in storage containers until later processing. This makes it possible to carry out individual processing steps independently of one another both in terms of time and location.

Starting material for a separation in a separating device, such as a mill 110, can, for example, be paper, cardboard, nonwoven, plant fibers, etc. The starting material or original material or the fibers 500 can have a moisture content of 0-60% by weight of water. In further embodiments, the starting material or original material or the fibers 500 have a moisture content of 5-40% by weight of water. In still further embodiments, the starting material or original material or the fibers 500 have a moisture content of 7-25% by weight of water. The moisture content of the fibers 500 can relate to the state both after the separation and after the premolding to form a preform 200.

After the separation in a separating device, individual fibers 500 are present, which are in a length spectrum of a few micrometers to, for example, 6 mm depending on the material used. Depending on their length, the fibers 500 have different properties. Thus, in principle, higher strengths can be achieved in molded parts 300 with long fibers, but long fibers exhibit poor formation, i.e., it is generally possible to achieve only a non-uniform distribution on the product surface with long fibers (e.g., in the range of 4 to 6 mm). In contrast, short fibers (1-2 mm) have a lower strength with good formation. The density of a finished molded part 300 is decisively influenced by fines (fiber parts) of a length of less than 1 mm, the proportion of which is basically higher in the case of short fibers. Thus, higher compressions can be achieved with shorter fibers or fiber fractions, whereby the mechanical properties and barrier properties of a product or molded part 300 can be influenced. A very dense fiber layer can be produced, for example. Overall, the properties of the molded part 300 to be produced can thus also be influenced by the length of the fibers 500.

It can furthermore happen that individual fibers 500 adhere to one another and form a fiber bundle. Such a fiber bundle is here also considered to be a separated fiber 500. What is decisive here is that such a fiber bundle has, for example, only a few fibers, for example 3-5 fibers, and thus behaves similarly to an individual fiber. This applies in particular with regard to the length of the fiber bundle and the weight thereof so that all fibers 500 and fiber bundles react identically during processing and can be processed substantially identically.

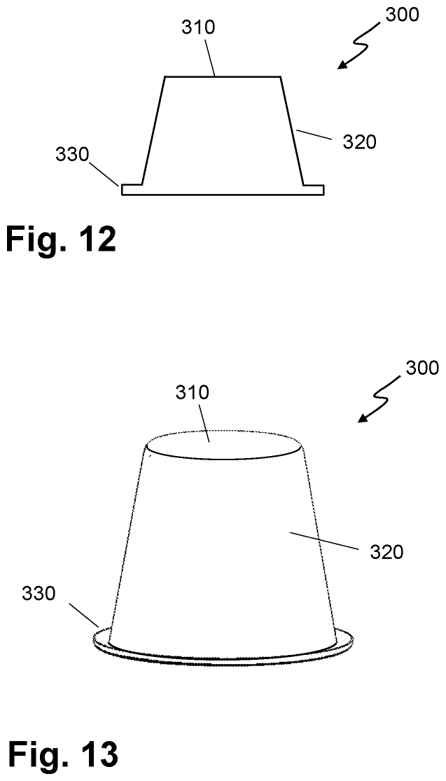

The fiber processing device 100 makes it possible to produce molded parts 300 which are biodegradable and themselves can again serve as a starting material for the production of three-dimensional molded parts 300 (see FIGS. 12, 13) made of a fiber-containing material and can be composted because they can generally be completely decomposed and do not contain any unacceptable, environmentally hazardous substances. The molded parts 300 can, for example, be designed as cups, covers, trays, capsules, plates and further molded and/or packaging parts (e.g., as holding/support structures for electronic devices).

In the exemplary embodiment of FIG. 1, the fiber processing device 100 has a mill 110 which serves as a separating device for separating a fiber-containing original material in order to provide separated fibers 500. Such a mill 110 can, for example, be a hammer mill or a whirl mill, which accomplishes separation and comminution of the fibers contained in the original material.

The fiber processing device 100 has a feeding device 120 for feeding separated fibers 500 to a premolding device 130. The feeding device 120 can, for example, have a feed duct 122. The fibers 500 are introduced into the feed duct 122 and transported within the feed duct 122 to a premold 132 of a premolding device 130. The transport of the fibers 500 can take place via a carrier medium. A gas or gas mixture can serve as the carrier medium, for example. For example, air is used as a carrier medium for the separated fibers 500. The fibers 500 can be transported via the carrier medium in the feed duct 122 by means of a fan 170 and can be fed to at least one premold 132.

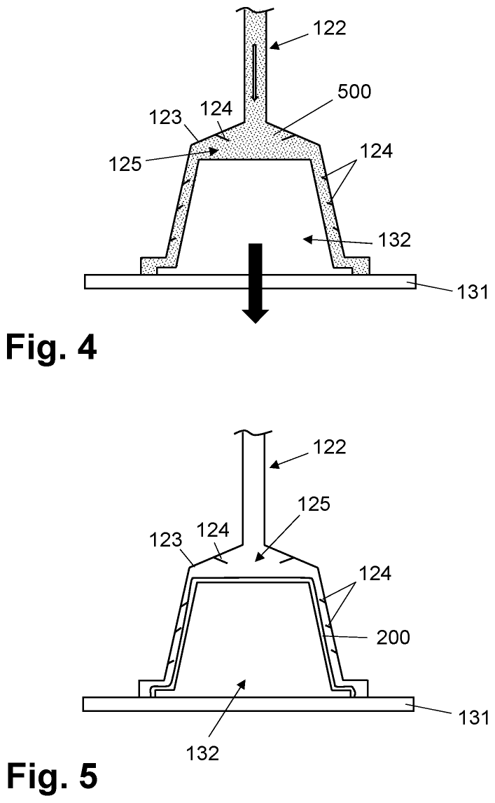

The premolding device 130 of the fiber processing device 100 has at least one premold 132, which has a surface 133 which corresponds to the form and shape of an inner or outer side of a three-dimensional molded part 300 to be produced. Fibers 500 fed via the feeding device 120 can be deposited on the surface 133. The deposited fibers 500 arranged on the surface 133 of the at least one premold 132 then form a preform 200 which substantially corresponds to the form and shape of a molded part 300 to be produced. In the embodiments of FIGS. 4-11, the surface 133 of the premold 132 forms the inner surface of a molded part 300 formed as a cup. A layer of loose fibers 500 is arranged on the surface 133, wherein the layer corresponds to the form and shape of the molded part 300 to be produced but has a greater wall or material thickness in comparison to a molded part 300 to be produced, since the fibers 500 are arranged in a loose compound on the surface 133.

For this purpose, the fiber processing device 100 can have a suction device 160, which is connected to openings 134 on the surface 133 of the at least one premold 132. By providing a relative negative pressure, sucking of fibers 500 can thus be achieved, which then collect on the surface 133. The suction device 160 is designed such that it generates a relative negative pressure at the openings 134. The premold 132 can, for example, have internal channels which are connected via a common channel to the suction device 160 or directly to the suction device 160. The premold 132 may also be substantially hollow inside so that within the cavity in the premold 132 can be provided a negative pressure, which leads to suction of fibers 500 via the openings 134.

The cavity is likewise fluidically connected to the suction device 160. The fiber processing device 100 has a transfer device 140 for transferring preforms 200 produced in the premolding device 130 to a molding device 150. The transfer device 140 can, for example, have at least one suction device, which sucks preforms 200 produced in the premold 132 and deposits them onto a corresponding mold body 152. For this purpose, the suction device can be connected to the suction device 160 for providing a relative negative pressure for the suction and lifting of preforms 200. The at least one suction device can, for example, have a receiving region 142, the inner side of which substantially corresponds to the outer or inner contour of a preform 200. In further embodiments, a suction device can first be pressed onto the preform 200 in order to pre-compress the latter before a suction and lifting from a premold 132 takes place. Here, a pressure of, for example, 0.1 MPa to 0.6 MPa can be applied via a press of the transfer device 140.

The molding device 150 has molding tools which are designed for pressing preforms 200. In the pressed state, the molding tools form a cavity, which corresponds to the final form and shape of the three-dimensional molded part 300 to be produced. Since the preforms 200 already substantially have the final form of the molded part 300 to be produced, only compression by pressing the fibers, but not deformation or stretching, must take place in the molding device. A pressure in the range of 1-80 MPa is applied for pressing. For this purpose, the molding device 150 has a press. The press can be designed, for example, as a toggle press. In alternative embodiments, a hydraulic or pneumatic press or a servo-spindle press can also be provided. Furthermore, a press can carry out pressing electrically, electromagnetically or via a spindle drive.

The fiber processing device 100 has a controller 180 which controls the operation of the fiber processing device 100 and the components thereof for the production of three-dimensional molded parts 300. The controller 180 is connected to the aforementioned components and to supply units 190 and at least one interface 192, as schematically shown in FIG. 1. In further embodiments, the controller 180 can communicate with the components via, for example, a control BUS, data lines and/or wirelessly.

Via the interface 192, control commands and information can be exchanged with further devices and/or controllers. The at least one interface can, for example, have connections for wireless communication (WLAN, NFC, radio, etc.) or a communication via a physical communication line.

Supply units 190 include, but are not limited to, cooling systems, lubricating systems, monitoring systems, hydraulic and/or pneumatic systems, and the infrastructure for the components of the fiber processing device 100 and of the aforementioned systems. This also relates to lines, pipes, valves, etc.

The components in the fiber processing device 100 can be combined into one unit. In further embodiments, a fiber processing device 100 can also be subdivided into multiple units, which are not structurally connected to one another, wherein, instead of a common controller 180, decentralized controllers for each unit are in each case provided additionally.

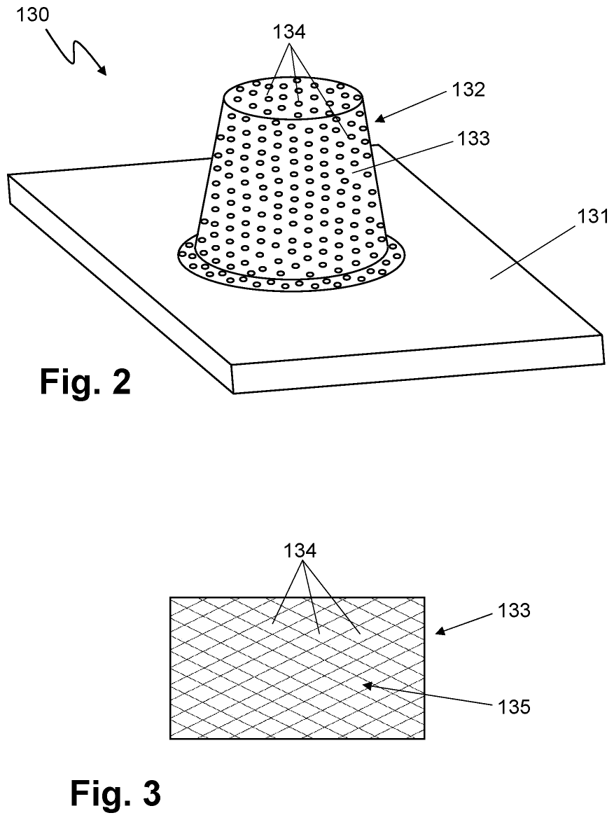

FIG. 2 shows a schematic representation of a premold 132 of a premolding device 130 of a fiber processing device 100. The premold 132 is arranged on a tool plate 131. The at least one premold 132 can be an integral part of the tool plate 131 or detachably connected thereto. A reversible connection makes it possible to arrange various premolds 132 on a tool plate 131. The premolds 132 can, for example, be detachably connected to the tool plate 131 by means of fastening elements, such as screws.

The surface 133 of the premold 132 substantially corresponds to the three-dimensional shape of the molded part 300 to be produced. In the exemplary embodiment shown in the figures, a cup is produced, for example, as a three-dimensional molded part 300 via the fiber processing device 100. The molded part 300 has a bottom 310, a surrounding side wall 320 and an edge 330 (see FIGS. 12, 13). Such a molded part 300 has a receiving space which circumferentially surrounds the side wall 320 and is delimited downward by the bottom 310. An inner wall, facing the receiving space, of the side wall 320 of a preform 200, which is pressed in a downstream processing step to form a three-dimensional molded part 300, is formed substantially on the surface 133 of the premold 132, wherein an edge 330 of a preform 200 is likewise formed in an edge region of the premold 132 on the surface 133. Thus provided is a preform 200, which already has the final geometry of the three-dimensional molded part 300 to be produced.

A plurality of openings 134 is arranged on the surface 133. The openings 134 are connected to the suction device 160 via a cavity in the interior of the premold 132 or channels in the premold 132. Thus, in the region of the openings 134 can be generated a relative negative pressure, which has the result that fibers 500 brought into the vicinity of the surface 133 collect on the surface 133. The size of the openings 134 can be selected such that no fibers 500 can pass through the openings 134 into the interior of the premold 132. The size of the openings 134 can be adapted and formed with regard to the size of the separated fibers 500. The diameter of the fibers 500 and the length of the fibers 500 can be taken into account.

In further embodiments, the number and/or size of openings 134 can be selected in accordance with a predetermined layer thickness for a molded part 300 to be produced, so that more or fewer fibers 500 collect accordingly in defined regions. For example, in a transition from an edge 330 to a side wall 320, no, fewer or smaller openings 134 can be provided in comparison to the rest of the surface 133, because an accumulation of fibers 500 could otherwise arise, which would ultimately lead to thickening in the finished molded part 300 in this region.

The premold 132 and the tool plate 131 can consist of a metal, a metal alloy or plastic. For example, aluminum or an aluminum alloy for the premold 132 and the tool plate 131 can be used.

In contrast to FIG. 2, multiple premolds 132 can be arranged on a common tool plate 131 in further embodiments. In this case, a feeding device 120 can be designed such that a feeding of separated fibers 500 is carried out uniformly to the premolds 132. The design of a premold 132 can be formed both as a positive or negative of the molded part 300 to be produced.

FIG. 3 shows a schematic representation of a surface portion of the surface 133 of a premold 132 with a mesh-like structure 135, which represents an alternative to the design of the openings 134 shown in FIG. 2. In further embodiments, the design of the surface 133 and the openings 134 can include different designs. For example, a screen-like structure 135 with openings 134 can be provided. The layer of a premold 132 on the surface 133 can, for example, consist of a plastic, which is arranged on a support structure. In this case, a screen-like design can be carried out analogously to known designs of the prior art, wherein a structure 135 similar to the design of a screen belt is arranged on a support structure. A structure 135 with openings 134 can, for example, consist of a technical yarn which is produced or knitted in a weaving or knitting type suitable for the creation of the surface 133.

The negative pressure or the vacuum in the region of the openings 134 is adjusted such that fibers 500 are not sucked into the interior of a premold 132 via the openings 134. In further embodiments, an adjustment of the negative pressure can take place during the arrangement of fibers 500 on the surface 133, so that the suction effect is increased until a desired layer strength or layer thickness is reached, so that fibers 500 can continue to be sucked even in the case of a layer of fibers 500 on the surface 133. Since the fibers 500 are not yet compressed, the space between individual fibers 500 can be sufficiently large in further embodiments to continue to maintain a suction effect when fibers 500 have already deposited on the surface 133.

FIGS. 4-11 show schematic representations of individual production steps in the production of three-dimensional molded parts 300 from a fiber-containing material. For this purpose, reference is made to the aforementioned components of a fiber processing device 100 which can form a structural unit in a plant or machine.

FIG. 4 shows a processing step in the production of three-dimensional molded parts 300, wherein a feed duct 122 is arranged on a premold 132. The feed duct 122 can, for example, be a separate unit of a feeding device 120. Thus, in further embodiments, one feed duct 122 per premold 132 can be provided. In further embodiments, feed ducts 122 for premolds 132 can also be designed as channels in a tool body of the feeding device 120. In this case, the tool body per premold 132 has an assigned channel on a tool plate 131. The channels or feed ducts 122 in the above embodiments can be connected to a common feed channel of a feeding device 120. Previously separated fibers 500 can then be introduced into the feed channel and blown to the premolds 132 via air as the transport medium. For this purpose, air can be introduced via a fan 170 as the transport medium, which accomplishes the transport of the separated fibers 500.

In further embodiments with a premold designed as a negative of the product to be produced, a “feed duct” can be designed as a stamp which dips into the premold and introduces fibers 500. In still further embodiments, a feed duct can also be designed as a basin from which dry fibers 500 are sucked, wherein, for this purpose, a premold 132 dips into the basin and sucks the fibers 500 via openings in the surface of the premold 132.

The feed duct 122 is arranged in relation to the premold 132 such that a wall 123 of the feed duct 122 is sufficiently spaced apart from the surface 133 of the premold 132 and the lower edge of the feed duct 122 rests sealingly on the tool plate 131 so that no fibers 500 can escape in the contact region between the feed duct 122 and the tool plate 131. For this purpose, seals can be provided on the edge of the feed duct 122 and/or in the contact region of the tool plate 131. It can thus be ensured in further embodiments that no fibers 500 are pressed out of the space 125 even at high pressures between the wall 123 and the surface 133 and/or with turbulent air flows in the space 125.

The distance between the wall 123 and the surface 133 is so great that fibers 500 can be distributed substantially uniformly in the space 125. The distance is greater than a maximum layer thickness of a preform 200, which is produced on the surface 133 by collecting fibers 500, so that all regions of the surface 133 are always accessible for the fibers 500, even if the formation of a preform 200 is completed. In further embodiments, however, the distance between the wall 123 and the surface 133 can substantially correspond to the layer thickness of a preform 200.

In the exemplary embodiment shown in FIG. 4, optional deflection plates 124 are arranged on the wall 123. The deflection plates 124 project into the space 125 and bring about a targeted swirling of the carrier medium flowing in from above with the transported fibers 500. The deflection plates 124 are oriented accordingly for the deflection and can be arranged, for example, at defined distances and/or circumferentially on the wall 123. The orientation of the deflection plates 124 can take place taking into account the angle at which the carrier medium with the fibers 500 enters the space 125 or impinges on the wall 123 or wall portions and which dimensions the fibers 500 have.

In the exemplary embodiment of FIG. 4, the distance between the wall 123 and the surface 133 is selected so large that the deflection plates 124 are still spaced apart from the preform 200 after the formation of a preform 200.

In the processing step shown in FIG. 4, fibers 500 are introduced via the transport medium into the feed duct 122 and the space 125, as shown schematically by the arrow. The fibers 500 are distributed uniformly within the space 125 and collect on the surface 133 due to negative pressure in the premold 132, wherein the fibers 500 are sucked via the openings 134, as indicated schematically by the black arrow. The feeding of fibers 500 and the suction via the openings 134 are maintained until a desired layer thickness of a preform 200 is achieved. The quantity of fed fibers 500 and the duration of the feeding can be ascertained in advance. In alternative embodiments, the layer thickness can be measured during the introduction of fibers 500. For example, a contactless measurement can be carried out. In alternative embodiments, at least one sensor can project into the space 125, which provides feedback by means of contact as soon as a layer thickness of fibers 500 is reached. After the desired layer thickness has been reached, the feeding of new fibers 500 can be interrupted. The remaining fibers 500, which are located in the feed duct 122 and the space 125, are deposited on the surface 133 or on already deposited fibers of the preform 200.

In order for the fibers 500 to deposit completely on the premold 132 in the feed duct 122 and in the space 125, the feeding of new fibers 500 can be ended first. A fan 170 can subsequently be switched off. Lastly, the sucking of fibers 500 via the openings 134 is then ended. It is thus achieved that no fibers 500 remain in the feed duct 122 and in the space 125. In further embodiments, throttle flaps or other control elements, which can control the quantity of fed fibers 500, can be arranged in a feed duct 122 and/or in a feed channel. Depending on the position of the throttle flaps, complete closing of a feed channel and/or feed duct 122 can thus also take place in order to prevent the feeding of fibers 500. In such embodiments, it is not absolutely necessary to switch off a fan 170 and to completely prevent the feeding of fibers 500.

In further embodiments, a defined quantity of fibers 500 can be introduced into the respective spaces 125 of assigned premolds 132 so that no direct measurement of the layer thickness is required. The required quantity of fibers 500 can be determined or ascertained in advance for a corresponding preform 200. In the production of preforms 200, only a defined quantity of fibers 500 must be introduced in each case. The quantity of fibers 500 can, for example, be ascertained and controlled via the weight.

The design of the premolding device 120 shown enables the production of preforms 200 with a constant layer thickness. Depending on the design of the openings 134 and their position, other layer thicknesses for preforms 200 can also be achieved in further embodiments.

After the fibers 500 have been introduced, they are arranged on the surface 133 until a preform 200 with a relatively loose structure of fibers has been produced. FIG. 5 shows the state after the production of a preform 200 on the premold 132. In the exemplary embodiment shown, the layer thickness of the preform 200 is so great that there is a distance between the deflection plates 124 and the outer surface of the preform 200. In embodiments without deflection plates 124 on the wall 123, the distance between a preform 200 and a wall 123 can be correspondingly smaller.

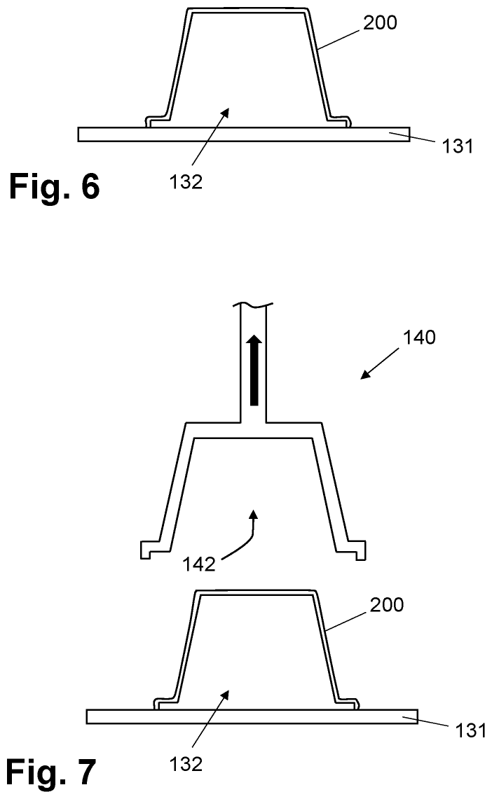

After the production of preforms 200, the feed duct 122 or a tool body with internal channels are removed from the tool plate 131 and at least one premold 132. The at least one preform 200 then rests, freely accessible, on the premold 132, as shown in FIG. 6.

Subsequently, a transfer device 140 is moved to the at least one premold 132 in order to receive the at least one preform 200 as shown in FIG. 7. For this purpose, the transfer device 140 has at least one receiving region 142 which substantially corresponds to the shape or outer contour of the preform 200. In further embodiments, a transfer device 140 can have multiple receiving regions 142 for corresponding preforms 200. The receiving region 142 has openings in order to generate a negative pressure which is necessary to lift the preform 200 from the premold 132 and to hold it in the receiving region 142. A suction is indicated in FIG. 7 by the black arrow. For this purpose, a connection to the suction device 160 can exist in order to control the suction and holding of preforms 200.

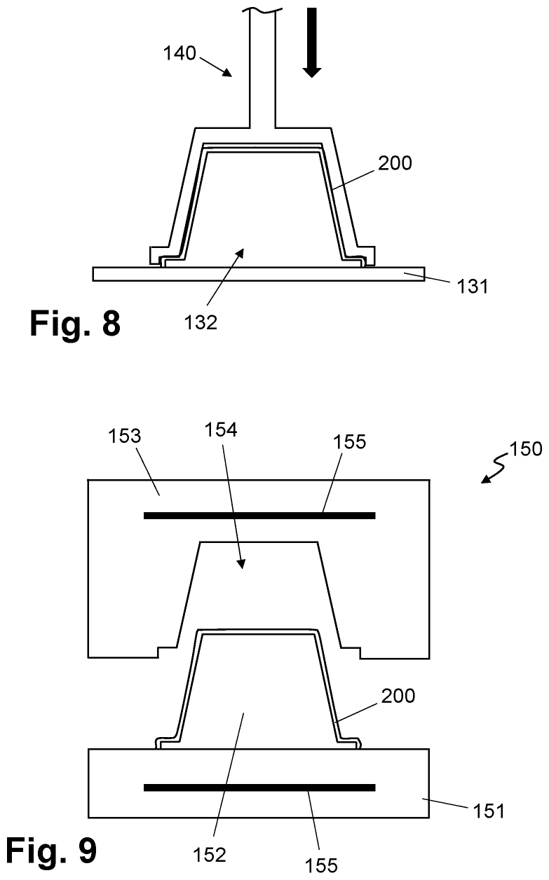

In further embodiments, the transfer device 140 can additionally serve to pre-compress preforms 200, as shown in FIG. 8 and indicated by the arrow. For this purpose, the transfer device 140 presses the receiving region 142 onto the preform 200. The pressure for the pre-compression can, for example, be 1 MPa to 3 MPa and is applied via the transfer device 140. In further embodiments, pre-compression takes place in a range of 0.1 MPa to 0.6 MPa. For this purpose, the transfer device 140 can have a robot that can be moved in all spatial directions. A transfer tool, which has at least one receiving region 142, is arranged at a free end. In further embodiments, a separate tool for the pre-compression can also be provided.

After the pre-compression, the preform 200 is sucked and transferred to a molding device 150 by means of the transfer device 140. The transfer device 140 in this case deposits at least one preform 200 onto a mold body 152. After the preform 200 has been moved to the mold body 152 such that the preform 200 rests on the surface of the mold body 152, the suction is ended. The transfer device 140 is then moved away from the mold body 152, wherein the preform 200 remains on the mold body 152.

The mold body 152 is arranged on a lower tool plate 151. Analogously to the formation and arrangement of premolds 132 on the tool plate 131, multiple mold bodies 152, which are, for example, an integral part of the tool plate 151 or are detachably connected to the lower tool plate 151, can also be arranged on the lower tool plate 151. The connection can, for example, take place via fastening elements, such as screws.

The molding device 150 has an upper tool plate 153 which has at least one cavity 154. The cavity 154 together with an opposite lower mold body 152 forms the molding tools for pressing preforms 200 to form three-dimensional molded parts 300.

The tool plates 151 and 153 each have heating elements which serve for heating the tool plate 151, 153 and the mold body 152 as well as preforms 200 in order to achieve the connection of the fibers 500 at simultaneous pressure. For this purpose, the tool plates 151, 153 and the at least one mold body 152 consist of a material with very good thermal conductivity. For example, metals or alloys can be used for this purpose. In the exemplary embodiment shown, the tool plates 151, 153 and the at least one mold body 152 consist of aluminum.

The heating elements 155 can, for example, be heating cartridges which can be controlled via the controller 180. Heating cartridges can be operated in a wide temperature range in accordance with the applied voltage. Heating in the range of 60° C. to 300° C. can take place via the heating elements 155.

After placing the preform 200 onto the mold body 152, the molding device 150 is closed, for which purpose the upper tool plate 153 is moved to the lower tool plate 151. For this purpose, the tool plates 151, 153 can be arranged in a press which enables a relative linear displacement of the tool plates 151, 153. FIG. 9 shows a state in which the two tool plates 151, 153 are moved toward one another.

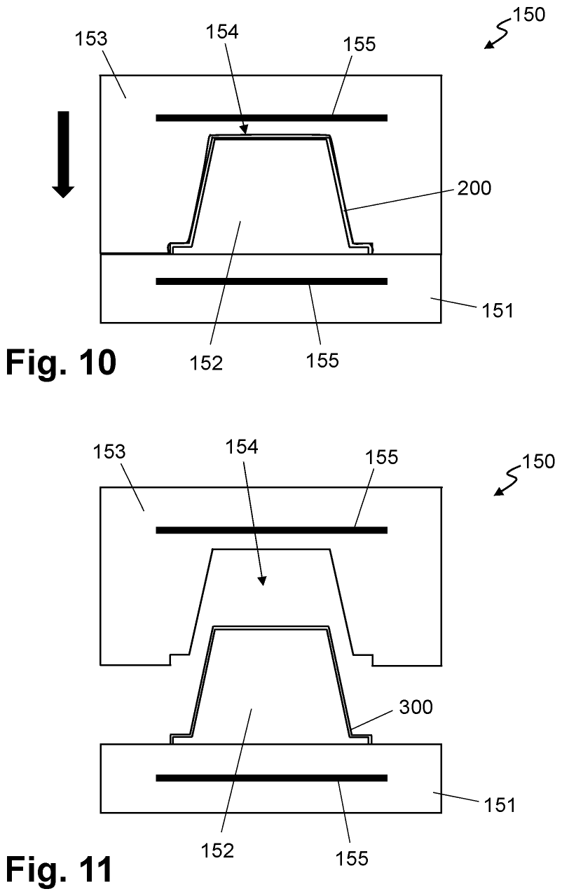

FIG. 10 shows the processing step of pressing 460, wherein, at a pressure in the range of 4-80 MPa, with simultaneous heat input in the aforementioned temperature range, the preform 200 is pressed to form a finished molded part 300. In this case, fibril aggregation of the fibers 500 takes place, wherein a particularly strong fiber-to-fiber connection of the fibers 500 is achieved. A molded part 300 thus pressed has very good mechanical properties with regard to strength and modulus of elasticity in comparison to plastics.

When the molding device 150 is closed, the fibers of the preform 200 are pressed as soon as the surface of the cavity 154 comes into contact with the surface of the preform 200 while the closing movement is continued. In the closed state of the molding device (FIG. 10), the thickness of the preform 200 is reduced to the final thickness of a molded part 300, wherein the cavity formed between the surface of the cavity 154 and the surface of the mold body 152 in the closed state of the molding device corresponds to the volume and the geometry (size, diameter, thickness) of the molded part 300 to be produced.

After the pressing of the preform 200 to form a three-dimensional molded part 300, the molding device 150 is opened again by a relative displacement of the two molding tools, namely the lower tool plate 151 with the at least one mold body 152 and the upper tool plate 153 with the at least one cavity 154, as shown in FIG. 11. After the opening of the molding device 150, the molded part 300 can be received by a transfer device 140 or another transfer tool and be placed, for example, onto a transport device, such as a conveyor belt, and fed to further processing (filling, closing, stacking, etc.) or a packaging device.

The production of the molded part 300 is significantly simplified in comparison to known production methods and production devices from the prior art since no stretching occurs because the preform 200 already has the three-dimensional shape of the molded part 300 to be produced and a material addition can thus be dispensed with. The thickness of both a preform 200 and a molded part 300 can therefore be smaller. Small thicknesses allow faster pressing to be carried out than in the case of molded parts with larger wall thicknesses. A decisive advantage is that, in comparison to the prior art, no nonwoven-like layer is provided, which is subsequently stretched and pressed, but that a nonwoven preform 200 that substantially corresponds to the shape of the three-dimensional molded part 300 to be produced is already produced.

FIGS. 12, 13 show schematic representations of three-dimensional molded parts 300. FIG. 12 shows a molded part 300 that has been produced according to a sequence shown in FIGS. 4-11 and is essentially designed as a cup. The cup or the molded part 300 has a bottom 310, a circumferential side wall 320 extending from the bottom 310, and a circumferential edge 330, which is oriented parallel to the bottom 310, on the end of the wall 320 opposite the bottom 310.

FIG. 13 shows a further design of a molded part 300, which is likewise designed as a cup. In contrast to the molded part 300 shown in FIG. 12, the edge 330 of the molded part 300 from FIG. 13 is substantially U-shaped. Such a design can also advantageously be achieved with the method described herein and a fiber processing device 100. For this purpose, the surface 133 of an associated premold 132 is correspondingly U-shaped in the edge region. The design and position of openings 134 in the surface 133 in the region of the edge 330 can be different to the design of the surface 133 in the region of the side wall 320 and/or of the bottom 310 in order to achieve a homogeneous uniform layer thickness even in the U-shaped edge of a preform 200 and thus of the molded part 300 to be produced. For example, in a depression of the premold 132 in the region of the U-shaped edge, fewer openings 134 can be provided because, due to the closeness of the openings 134 on account of the curvature, the suction effect even in the case of fewer openings 134 is exactly as large as with a planar surface 133 with more openings 134 in comparison to the depression.

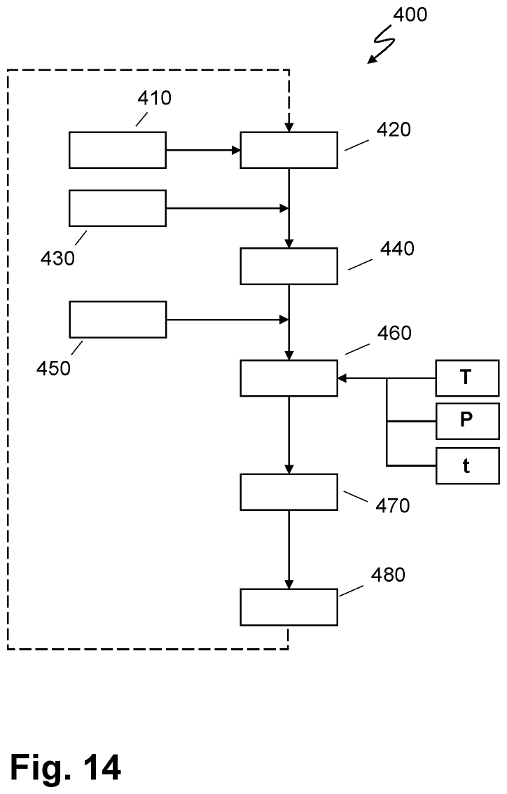

FIG. 14 shows a method 400 for the production of three-dimensional molded parts 300 from a fiber-containing material with reference to the above description of fiber processing devices 100, and the production steps for producing a three-dimensional molded part 300.

In a first optional method step 410, fibers 500 are separated from a starting material (plants, waste paper, nonwoven, fluff pulp, etc.). The separation can be carried out via a mill 110, such as a hammer mill or the like. The separation of fibers 500 can take place both independently of the further processing of the fibers 500 both in terms of time and location.

In a method step 420, the individual fibers 500 are provided for further processing. As an alternative to the provision by separation in a method step 410, the provision can also take place by feeding fibers 500 from a storage.

After the provision in method step 420, feeding 430 can be carried out via, for example, a feed duct 122 or feed channel of a feeding device 120. The feeding of fibers 500 is then achieved, for example, with the aid of a carrier medium, such as air, wherein a fan 170 or the like is provided for this purpose in order to transport the fibers 500 by means of the carrier medium.

Subsequently, in a method step 440, the fibers 500 are arranged on the surface 133 of a premold 132 of a premolding device 130, wherein a preform 200 is produced by the arrangement of the fibers 500. The premold 132 substantially has the shape of the molded part 300 to be produced, so that, as a result of the fibers 500 arranged on the surface 133, the preform 200 substantially takes the final geometry of the molded part 300 to be produced.

After the method step 440 of arranging the fibers 500 on the surface 133 of a premold 132, a transfer of formed preforms 200 can take place in a method step 450. In further embodiments, the method step 450 of transferring can be carried out directly after the method step 440 of arranging the fibers 500 and of forming preforms 200 or at a different time and/or location. Preforms 200 formed can be stacked in further embodiments and fed to further processing, e.g., pressing 460, which is carried out at a later point in time at another location.

After the production of preforms 200, pressing 460 in a molding device 150 takes place in a downstream processing step. The molding device 150 can, for example, have two molding tools with at least one mold body 152 and a corresponding cavity 154, as described above.

The pressing 460 takes place a pressure P in the range of 4-80 MPa, wherein simultaneous heating of preforms 200 in a temperature field t of 60 to 300 degrees Celsius, as a function of the geometry of molded parts 300 to be produced or of preforms 200 and of the fibers 500 used and, where applicable, of further additives and/or properties to be achieved, is carried out for a definable time period t.

After the pressing 460, a three-dimensional molded part 300 is provided in method step 470. In a further method step 480, additional processing of three-dimensional molded parts 300 can subsequently take place. For example, further processing can include coloring, coating, filling and/or stacking molded parts 300.

The method 400 is characterized in that no support structures (e.g., tissue) or coatings are required in order to achieve sufficient stability of a nonwoven-like layer for further processing and stretching. Instead, preforms 200 that already have the final geometry of molded parts 300 to be produced can be produced solely by fibers 500. By means of an optional method step of pre-pressing between a processing step 440 of arranging and the processing step of pressing 460, the structure of preforms 200 can additionally be solidified, which further improves handling and enables transfer to further stations without support structures etc.

A further advantage is that no material addition is required due to stretching, as absolutely necessary in the prior art, so that less material is required for the formation of preforms 200 or molded parts 300 with the same mechanical properties.

The methods 400 described herein and the fiber processing devices 100 can be used to produce molded parts 300 that can have different geometries. The cup-like molded parts 300 shown in the figures are not the only possible geometries and forms. Furthermore, the methods 400 and fiber processing devices 100 described herein achieve that three-dimensional molded parts 300 with large “mold depths” can in particular be provided. Until now, so-called dry-fiber processing methods were limited to low mold depths because stretching of fibers was possible only in a very small region despite the material addition.

### LIST OF REFERENCE SIGNS

100 Fiber processing device
110 Mill
120 Feeding device
122 Feed duct
123 Wall
124 Deflection plate
125 Space
130 Premolding device
131 Tool plate
132 Premold
133 Surface
134 Opening
135 Structure
140 Transfer device
142 Receiving region
150 Molding device
151 Lower tool plate
152 Mold body
153 Upper tool plate
154 Cavity
155 Heating element
160 Suction device
170 Fan
180 Controller
190 Supply units
192 Interface
200 Preform
300 Molded part
310 Bottom
320 Side wall
330 Edge
400 Methods
410-480 Method steps
500 Fibers

1. A method for production of three-dimensional molded parts from a fiber-containing material, at least having the following steps:
providing separated fibers,
arranging the separated fibers to form at least one preform, wherein the at least one preform substantially corresponds to a shape of a molded part to be produced, and
pressing the at least one preform to form a three-dimensional molded part.

2. The method according to claim 1, wherein pre-pressing the at least one preform takes place after arranging the separated fibers to form at least one preform.

3. The method according to claim 1, wherein the arrangement of the separated fibers and the pressing of the at least one preform take place continuously and coordinately or discontinuously.

4. The method according to claim 1, wherein fibers made of a fiber-containing material are separated for a provision in an upstream step.

5. The method according to claim 1, wherein the pressing of the at least one preform to form the three-dimensional molded part takes place under an action of heat.

6. The method according to claim 1, wherein the separated fibers of at least one premold are fed to a premolding device, wherein the separated fibers are uniformly distributed on a surface of the premold and the premold substantially corresponds to the shape of the molded part to be produced, whereby the at least one preform is formed.

7. The method according to claim 6, wherein, after the premolding, the at least one preform is transferred to a molding device and the at least one preform is pressed in the molding device to form the three-dimensional molded part.

8. The method according to claim 6, wherein the separated fibers are blown into or onto the surface of the premold and/or are sucked via the surface of the premold.

9. A fiber processing device for producing three-dimensional molded parts from a fiber-containing material, at least having a feeding device for providing separated fibers; a premolding device, which has at least one premold for forming preforms from fibers fed separately, which corresponds to a final form of the molded part to be produced; a transfer device for transferring the preforms provided via the at least one premold and made of fiber-containing material; and a molding device for pressing the preforms to form finished three-dimensional molded parts.

10. The fiber processing device according to claim 9, wherein the at least one premold has a surface having openings at least partially.

11. The fiber processing device according to claim 10, wherein a size of the openings is different.

12. The fiber processing device according to claim 10, wherein the surface has a mesh-like or screen-like structure.

13. The fiber processing device according to claim 10, wherein, via the openings in the surface of the at least one premold, the separated fibers being configured to be sucked via a suction device.

14. The fiber processing device according to claim 9, wherein the feeding device has a fan, via which the separated fibers are configured to be introduced into the at least one premold.

15. The fiber processing device according to claim 9, wherein the feeding device has at least one feed duct, which opens into the at least one premold.

16. The fiber processing device according to claim 15, wherein the feed duct terminates flush with a surface of the at least one premold.

17. The fiber processing device according to claim 9, further having a mill for providing the separated fibers from a starting material.
